(19) United States
(12) Patent Application Publication
(10) Pub. No.: US 2008/0208815 A1
(43) Pub. Date: Aug. 28, 2008

(54) Method And System For Optimizing Investments In Web Marketing

(76) Inventor: Sean Taylor, Sebastopol, CA (US)

Correspondence Address: FISH & ASSOCIATES, PC;ROBERT D. FISH, 2603 Main Street, Suite 1050, Irvine, CA, 92614-6232, US

(21) Appl. No.: 11/844,858

(22) Filed: Aug. 24, 2007

Related U.S. Application Data
(60) Provisional application No. 60/866,338, filed on Nov. 17, 2006.

(51) Int. Cl. G06F 17/30

(52) U.S. Cl. 707/3; 707/E17.001

(57) ABSTRACT

Contemplated systems and methods provide cost/benefit projections for alternative web site marketing strategies. In preferred embodiments the system classifies search terms into primary, secondary, and tertiary words, and projects Return on Investment (ROI) and Net Operating Income (NOI) for multiple permutations of the words. Preferred embodiments also include a budget optimizer function. In another aspect web search engines can be used to identify potential customers for the system, and to identify advertising opportunities.

This application claims priority to U.S. provisional application 60/866338, filed Nov. 7, 2006.

### FIELD OF THE INVENTION

The field of the invention is Search Engine optimization and utilization.

### DEFINITIONS AND ABBREVIATIONS

g-Word or g-Words: A word or words contained within a search term or search term phrase.

Search Term or Search Term Phrase: A word or phrase that has been used by an internet browser to perform a search.

Natural Listings: URL's that have been submitted, accepted and then ranked by the search engine's spider/algorithms and thus displayed and ranked on the search result pages accordingly; these URL's are typically displayed on the left side of the search results page.

Sponsored Listings: URL's that are ranked by advertiser bid amount. Only those URL's, submitted through a search engine advertising campaign, qualify for display and ranking. These URL's are typically displayed on the right hand side of the page as well as above and/or below the natural listings.

Click-Through: The record of an internet browser “clicking” on a hyperlink (advertisement or other) and thus being forwarded (advanced through) to a URL.

Hyperlink: A hyperlink (often referred to as simply a link), is a reference or navigation element in a document to another section of the same document, another document, or a specified section of another document, that automatically brings the referred information to the user when the navigation element is selected by the user.

### ABBREVIATINS

SE=Search Engine

ST=Search Term

SEM=Search Engine Marketing

SEO=Search Engine Optimization

CPC=Cost Per Click-Through

CTR=Click Through Ratio

PPC=Pay-Per-Click

### BACKGROUND

With the introduction and growth of the World Wide Web, beginning in the early 1990's, advertising and sales techniques broadened in concept to include online activities. Web sites were initially located by interested users first by word of mouth or direct user to user communication, while later conventional techniques such as media advertising began to be used to generate web site traffic. Additionally, hyperlinks located on other relevant or related web sites helped provide users the ability to “surf” or browse the web.

Still later, search engines offered the user an ability to enter keywords and generate a list of potentially relevant web sites. Originally the position of a particular web site in the list was related to the direct relevance of the query to the content of the web site, but as the value of a result position near the top of the list increased, it became possible with some search engines for the advertiser to pay for the privilege of being listed in “sponsored” areas. Thus advertisers are charged when the search engine delivers a user to their target URL.

While advertisers could now adjust their bid price to generate the level of desired web leads, the “cost per click” in many cases has grown dramatically. Alternatives to high click prices include all earlier online advertising techniques, which can generally be summarized by either relying on placement in natural listings or placing information about the target web site on other web sites. For example, “directory” web sites choose a theme and group related links and content together for user convenience, and placement of a link on a directory site is a common marketing approach. It is possible that charges for such advertising may be based on “impressions”, which are passive viewings rather than active clicks.

The relative advantages and disadvantages of each method are many and debatable, but in any case, the identification and selection of appropriate web investment strategies is far from easy.

Search engines assist by providing important data based on observation of a wide range of search terms and bids, and may offer API interfaces to facilitate automated collection of this data. For example, available tools can provide information broadening the range of search term choices and, by further estimating traffic volume of each search term, allow informed selection of search terms for a target web site. Other available tools allow estimation of a winning cost per click bid, given a set of keywords, and may compute estimated ROI given other parameters.

Such tools are valuable, but are not yet broad enough to account for many important and relevant factors, and in fact focus on only small but easily obtained data sets stemming from search engine activity.

Thus what is needed is a comprehensive system and method for generating critical data allowing for easy and rapid assessment of available web marketing investment opportunities for the purposes of optimizing ROI of online marketing resources and enhancing marketing strategies. For example, an inventive method delivering a deep understanding of the interaction of search terms by providing primary, secondary, tertiary (and so on) patterning and analysis of composite g-words and search term data, and by providing a focused user interface allowing the user to control and direct analysis of those terms and data, will produce optimized results over a wide range of success criteria. It is an element of the current inventive material to provide such method and apparatus, to extract such information under controllable conditions and to introduce analytical methods operating with the resulting information. Furthermore, a method of identifying, weighting and ranking all URL's appearing on SE result pages, over a given set of search terms or g-words and over a given set of search engines, will further produce optimized results over a wide range of success criteria. That is, given a set of search terms, the inventive material reveals the amount of viewer attention any given website is likely to receive relative to all other websites. This information, coupled with inventive analysis techniques, greatly eases the application of appropriate and relevant business factors to make online marketing and advertising decisions.

### SUMMARY OF THE INVENTION

The present invention provides innovative systems and methods to generate critical data by which a user may gain useful insight into the probable result of marketing decisions relating to web site promotion and operation. Resulting information may be used in many beneficial purposes, such as:
1) To reduce marketing costs for a given website traffic volume or to increase volume at similar expense.
2) To design or redesign marketing web optimization campaigns to quantify an expected return at a predictable cost.
3) To understand customer linguistic patterns for the purposes of improved online and offline product and service descriptions. Re; choose best words
4) To identify customer demand for current and possible new product and service offerings.
5) To identify industry brands for marketing/advertising/strategic partnerships.
6) To identify and prioritize portal site investment opportunities.
7) To understand competitor's SEO strategies and SE PPC campaign strategies and investment.

The method may accommodate user preferences in guiding the resulting analysis and optimization.

In a first preferred embodiment, the process focuses on capturing critical data concerning search terms and analyzing the result. Given a word or set of words of initial user interest, the inventive process gathers related search volume and advertising data through methods including search engine API access, screen scraping and/or private third party agreements.

In a further preferred embodiment the primary word or words would be formulated using a concordance technology that would extract and pattern relevant words from selected websites.

In a further preferred embodiment a primary word or words would be formulated by applying at least one of dictionary, thesaurus, misspellings or permutations to previously chosen primary words.

Considering related search terms, the process patterns related g-words, identified within a search term or search term phrase, into g-word groupings considered as primary, secondary, tertiary and so on. Search term data may be summarized or totaled by g-word groupings.

In a further preferred embodiment, such g-word groupings are based on g-word frequency within the captured search terms.

In a further preferred embodiment, such g-word groupings are based on a word that never occurs along with the primary word.

In a further preferred embodiment, such g-word groupings are based on SE volume and advertising data (ie., search volume, top bid, estimated cost per click-through, etc.)

In a further preferred embodiment some of the secondary g-word groupings contain at least one of the same search terms and the same search volume and advertising cost data.

In a further preferred embodiment no secondary g-word groupings contain at least one of the same search terms and the same search volume and advertising cost data.

This analysis process provides a user interface allowing viewing of primary, secondary, tertiary (and so on) g-word groupings and associated search term data, for the following purposes:

Building targeted and cost effective SE PPC campaigns: Because summarized SE search volume, estimated CT's and estimated CPC figures are available within the method, estimated marketing costs for a proposed investment may be computed as a function of those parameters. By interaction, the user may select and deselect g-word groupings and/or individual search terms until the predicted budgetary costs and investment requirements are in a desired range. An important novel aspect of the current inventive material is that within a given g-word group, further breakdown is possible. For example, within a group of secondary g-word groupings, the user may examine tertiary keywords and exclude or include particular search terms selectively within the secondary and tertiary g-word grouping.

In a further preferred embodiment, the user may order budget detail data columns to improve viewing and analyzing of data.

In a further preferred embodiment, the user may order the g-word groupings at least partially as a function of the number of g-words within a g-word grouping in a set of historical search data.

In a further preferred embodiment, the user may order the g-word groupings at least partially as a function of search volume frequency of the search terms associated with the g-words within a g-word grouping in a set of historical search data.

In a further preferred embodiment, the user may order the g-word groupings at least partially as a function of setting a low boundary for at least one of occurrence and search volume frequencies of selected ones of the g-word groupings in a set of historical search data.

In a further preferred embodiment, the user may order the g-word groupings at least partially as a function of setting a high boundary for at least one of occurrence and search volume frequencies of selected ones of the g-word groupings in a set of historical search data.

In a further preferred embodiment, the user may order the g-word groupings at least partially as a function of choosing relatively inexpensive ones of the g-words.

In a further preferred embodiment, the user may order the g-word groupings at least partially as a function of implementing an exclusion criterion.

In a further preferred embodiment, the user may filter budget detail data by using “filtering” options that allow user to enter data thresholds thus expanding or shrinking the data set to improve the ability to view and analyze the data.

Estimate NOI and ROI of Online Investments: In a further preferred embodiment, the user may enter business assumptions like estimated click-through ratio, estimated conversion rate of website visitors, average revenue per converted website visitor, monetary/advertising budget or budget range, maximum estimated cost per click-through and min./max. search volume per search term and other possible evaluation criteria that would help the user determine a basic NOI and ROI of his/her online advertising investment.

In a further preferred embodiment, the user's ST selections, used to define predicted budgetary costs and investment requirements as described above, could be downloaded and synchronized (looped) directly with the SE PPC campaign modules or other third party reporting tools. This would allow initial estimates, from the inventive methods, to be replaced with experiential data allowing the user to continually modify investment strategies to further reduce marketing costs for a given website traffic volume, increase volume at a similar expense and thus increase expected NOI and ROI of online investments.

In a further preferred embodiment a “Budget Optimizer” function would be available to the user to automatically allocate a users pre-determined advertising budget across available or pre-determined search terms identified in the primary, secondary and tertiary g-word groupings.

Understand Linguistic Patterns of Potential Customers: By gather, sorting and displaying search data into primary, secondary and tertiary g-word patterns, the user is offered a unique insight into the consumers preferred methods of describing products and services. This linguistic patterning can be used to modify and improve advertising and promotional copy. For instance a user selling only animal toys may use the term “animal toys” to promote his/her business both online and offline. However, using the inventive method may show, through the gathering, sorting and displaying of search data into primary, secondary and tertiary patterning, that consumers do not use the term “animal toys” in any recognizable volume. But rather, consumers use the term “stuffed animals” as the preferred description of the user's animal toy offerings.

Identifying New Product and Services Offerings: The inventive method captures expansive consumer data, using primary g-words around the user's interest, and often reveals consumer interest in similar products and services not yet discovered by the user. For instance, a user selling only animal toys may use the inventive method to analyze interest in the primary word “animal” and find that consumers are interested in animal videos, animal pictures and animal wallpaper; all of which could be future product offerings.

Identifying Industry Brands for Marketing/Advertising/Strategic Partnerships: The inventive method captures expansive consumer data, using primary g-words around the user's interest, and often reveals consumer recognized industry brands and/or potential competitors not yet recognized. For instance, a user selling only animal toys may find, in using the inventive method, that a large number of online consumers are searching for “animal planet”. This may prompt the user to pursue future marketing, distribution or business alliances with the Animal Planet company to increase sales and business activity.

In a further aspect of the current inventive material, the process focuses on identifying visual schematics of g-word groupings and associations. The process result of g-word groupings into primary, secondary, tertiary and so on g-word groupings may be presented in tabular form. When combined in tabular form with associated search volume data, the important g-words and search terms are made visible. The user may sort alphabetically by g-word, numerically by search volume or by other mathematical formulae such as total estimated cost or budget per keyword.

In still further preferred embodiments, a graphical user interface reveals the connective patterning and association with all other g-words, with the ability to navigate both higher and lower in the g-word hierarchy.

Systems associated with the preferred methods comprise computational resources communicatively coupled to the internet. Computations may be done with programs stored on the computing apparatus, or by distributed web applications that may involve clusters or groups of computational resources working in concert. There may be beneficial use of API or other access to search engines. Because the method is inherently computationally complex, the inventor contemplates use of all known hardware and software techniques of computational improvement, and all future techniques and improvements.

In a further preferred embodiment at least a portion of the search volume and advertising data as well as any analysis results or manipulation of such data could be stored for future use

In another aspect of the current inventive material, the user may select one or more desired words or search terms relevant to an interest of the user. The user may further identify known search engines whose results are desired to be included in the subsequent analysis. The user may also specify which search engine result positions (i.e, natural, sponsored, local, etc.) will be included in the subsequent analysis. Lastly, the user may weight the search terms by search volume, the search engines by relative total search traffic, and weight the search engine results positions by the expected click-through % of total viewer click-through to accommodate characteristics and behaviors of targeted customers.

In a further preferred embodiment the word, words or search terms would be formulated using a concordance technology that would extract and pattern relevant words from selected websites.

In a further preferred embodiment the word, words or search terms would be formulated by applying at least one of dictionary, thesaurus, misspellings or permutations to previously chosen primary words.

In a further preferred embodiment, the date range used to determine search term search volume may be specified, thus accounting for the possible time varying nature of search experiences.

Additionally, in more preferred embodiments, the depth of URL qualification to be resolved may be selected or specified, thus providing a broad or narrow site location targeting as may be desirable.

Given a user defined set of words or search terms relevant to the user's interest, the method creates the following:
1) A Search Term Table containing a list of search terms and associated search term impression volumes across all search engines selected by the user.
2) A Sites Table containing a list of site addresses (URL's) that were displayed on the search results pages; search result pages from search inquiries performed with all search terms (noted above) across all search engines selected by the user.
3) An Intersection Table containing the search terms, the site addresses and the resulting search position for each URL.
4) A Relevancy Weighting Table containing all possible search engine results positions (for each search engine) and the associated relevancy weighting factors for each search position and each search engine.
5) A Site Address Scoring Table containing the search volume for each search term, the search query result positions (across all search terms and all search engines selected), the URL listings that appeared in each of those positions and a related score for each site address based on the factors just mentioned.
6) A Sum Scoring Table containing each unique site address along with a “Total Score” column showing the cumulative score for each site address.

Based on a valuation process, as described above in the Site Address Scoring Table and the Sum Scoring Table, the resulting URLs are rated and ranked in terms of desirability. In a preferred embodiment, this valuation process is based on a URL's frequency of SE result appearance and the assumed value of each SE result appearance position. In other preferred embodiments valuation may be based on criteria that are established as needed to achieve the intended goals of the user.

The resulting information can be used to accomplish the following beneficial functions:
1) Assess the likelihood that a particular web site is accessed frequently with the targeted keywords or search terms.
2) Create a success metric for each URL, or ranking of such URLs.
3) Assess the likelihood that the set of search terms produces beneficial results for either the consumer or the web marketer.
4) Tracking positioning of any single URL (self or competitor/s) across all search terms and all search engines defined by user.
5) Prioritize research for portal site marketing opportunities available to user.

The inventive specifics of the assessment process produce a clear and easily understandable result, wherein the result is characterized by one or more of the following: hierarchically categorized keywords and search terms, ranked targeted URLs, a choice of investment options.

Competitive information can be obtained by targeting a competitor's or competitors' websites, and adjusting the positional selection criteria to focus only or disproportionally on sponsored search data, thus giving insight into competitors PPC search term strategies and PPC marketing budgets. Applying the process over a set of search terms, the application uses the sponsored position data of each search with data on estimated click-through costs and estimated number of click-throughs to determine the following competitive intelligence:
Search terms a competitor is bidding on
Position of every competitor ad placed on every search term
Approximate search volume, CTR and CT's for each ad and each search term
Total marketing budget spent on each search engine

Because the process of creating the above result can be automated, it can be treated as an inner loop to more global search and optimization methods, allowing very data intensive analysis.

In a further preferred embodiment, many marketing decisions and recommendations may be made automatically to maintain a particular strategy relative to competitors over time. For example, by monitoring a competitor's sponsored SE results positions as above, PPC bidding decisions can be made to maintain a sponsored result position “x” spots above or below that competitor, thus tracking and “echoing” changes in the competitors actions.

Affiliate, or portal site, advertising placement and marketing opportunities may also be obtained by adjusting the positional selection criteria to focus only or disproportionally on natural search data, thus giving insight into online advertising opportunities as an alternative to the increasingly expense PPC search engine ad placement. Applying the process over a set of search terms, the application uses the natural position data of each search to find, score and sort all possible affiliate or portal sites positioned to attract the user's online customers. The application then ranks these sites based on their total exposure across all search terms and search engines. This ranking provides a prioritized list of URLs where each URL may provide the user with one or all of the following benefits:
Free or paid advertising opportunities as an alternative to PPC advertising.
Distribution partnerships or strategic business alliances.
New competitor insight.

In a further preferred embodiment, a value designator would be assigned to the URL ranking results and this value designator, and associated web pages, would be published on a publicly accessible website.

In a further preferred embodiment, a form of compensation would be required for the authorized use of the value designator and URL ranking results.

### BRIEF DESCRIPTION OF THE DRAWINGS

FIG. 1. Primary word/s

FIG. 2. Application Analysis Results—Showing ST and PPC Advertising Data.

FIG. 3. G-word Patterning—Random—Primary, Secondary and Tertiary

FIG. 4. G-word Patterning—Grouped—Primary, Secondary and Tertiary

FIG. 5. G-word Group Analysis—Group Summary

FIG. 6. G-word Group Analysis—Group Filter and Layering

FIG. 7. Search Term Selection—Capacity to Select Individual Search Terms

FIG. 8. Data Sorting—By Volume Impression of Search Term

FIG. 9. Data Sorting—By Top Bid

FIG. 10. Data Sorting—By Estimated CPC by Search Term

FIG. 11. G-word Detail—Visual of Primary, Secondary & Tertiary G-Words

FIG. 12. G-word Detail—Sorted by Volume of Impressions

FIG. 13. G-word Relationships—Primary Keyword to Other G-Words

FIG. 14. G-word Relationships—Secondary Keyword to Other G-Words

FIG. 15. G-word Relationships—Tertiary Keyword to Other G-Words

FIG. 16. Definition of Search Result Terms, Positions and Criteria

FIG. 17. Description of Application Tables

FIG. 18. Description of Weighting and Relevancy Computations

FIG. 19. Description of Weighting and Relevancy Analysis Results

### DETAILED DESCRIPTION

Various objects, features, aspects and advantages of the present invention will become more apparent from the following detailed description of preferred embodiments of the invention, along with the accompanying drawings in which like numerals represent like components.

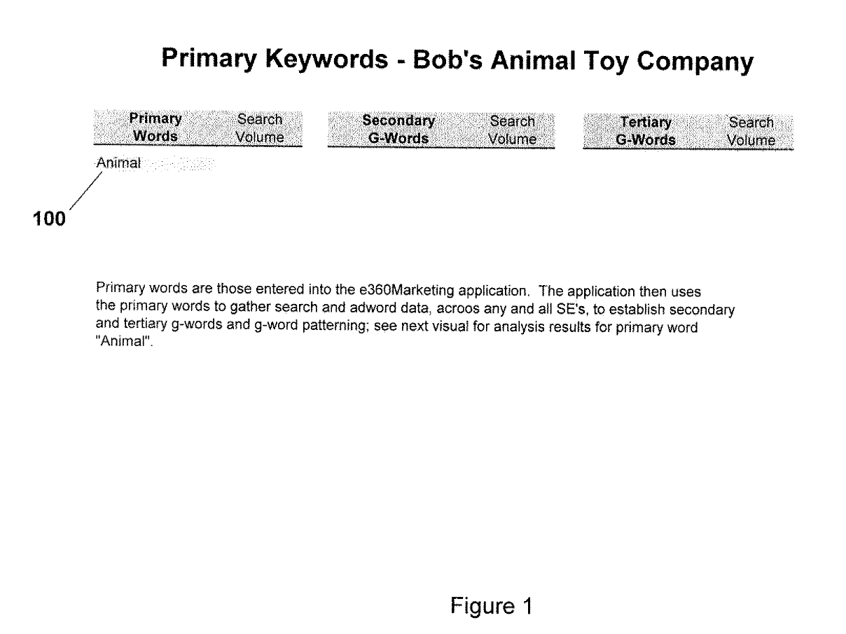

According to the current art the user will initially have a single word or set of words or phrases specific to his/her interest. As the user interacts with search engine functions in the current art, using existing g-words and combinations of g-words as search terms, additional words will be suggested by search engine routines, and may be added in unordered fashion to the existing set of words. In the inventive method herein, the concept of a keyword hierarchy will be introduced. FIG. 1 shows a beginning word 100. The keyword 100 may be thought of as Primary, as are any and all words or phrases initially selected by the user. Typically, these Primary words are formulated by the user based on his knowledge of the web subject space, or via interaction with search engine functions.

An improved and inventive method of determining these keywords and placing them into a multi-level hierarchy will be disclosed. This inventive method leads to a deep understanding of the web customer thinking and yields a powerful tool for further analytical use.

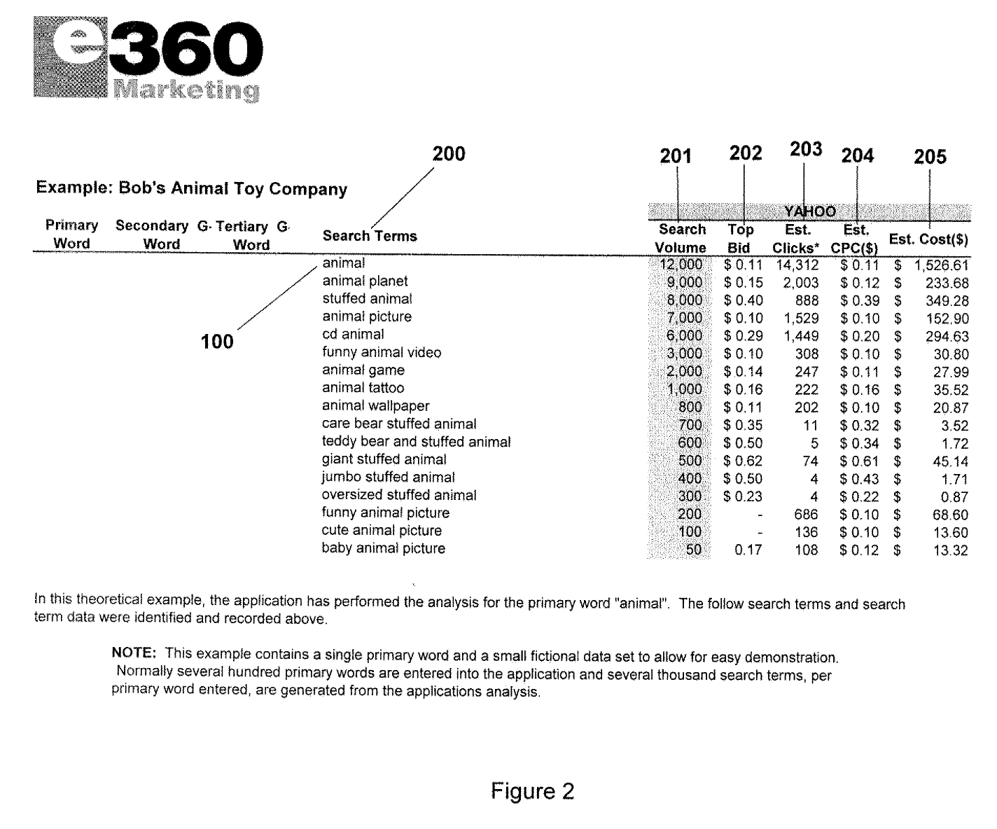

Typically, search engine utility functions provide information on actual ST's used to perform SE searches where those STs contain one or more of the original set of words. Consider FIG. 2, an illustrative example showing the current art after an initial word “animal” 100 is run through a typical search engine utility function that returns information on other actual searches containing the initial word “animal” 100. The column entitled “Search Terms” 200 lists the actual search terms returned by the search engine utility function for searches containing the word “animal” 100. Depending on the capabilities of the particular search engine involved, additional search data, provided for each ST, may include the volume of searches 201 over a specified time and date interval, the maximum bid amount 202, the estimated volume of CT's 203, the estimated CPC 204, and the estimated cost for all the CT traffic 205. It will be understood that this example contains a single primary keyword and a small fictional data set to allow for easy understanding. In practice, there may be several hundred primary words initially, and several thousand search terms for each primary word entered may be returned as a result, emphasizing the complexity of dealing with the current art.

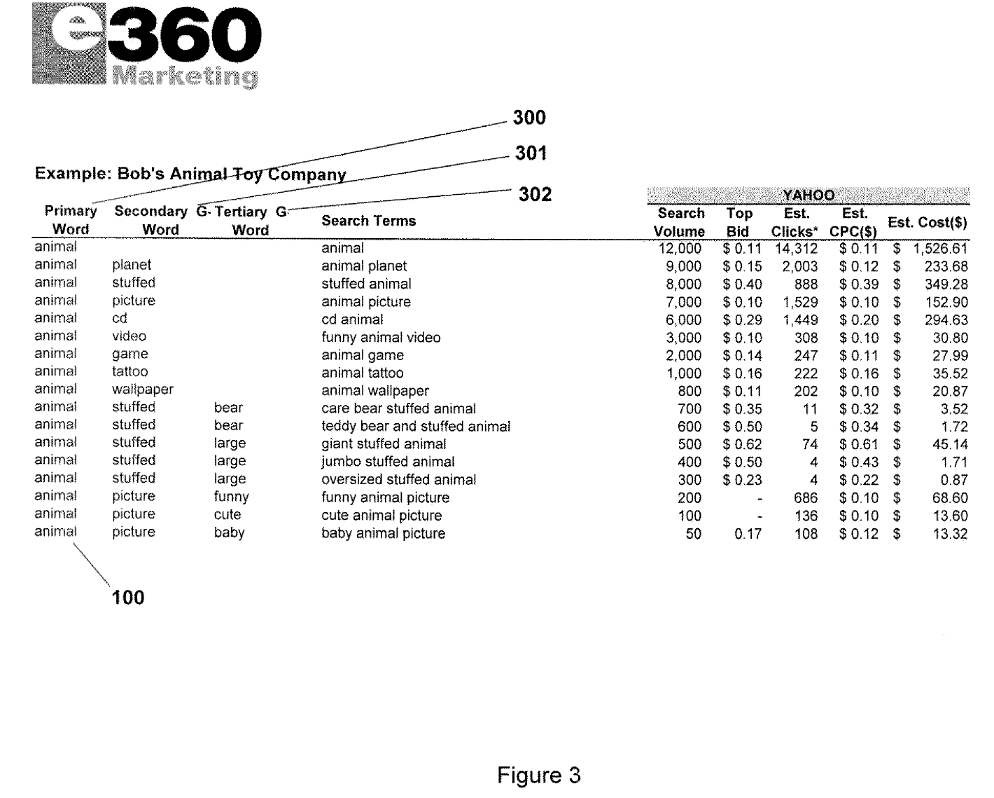

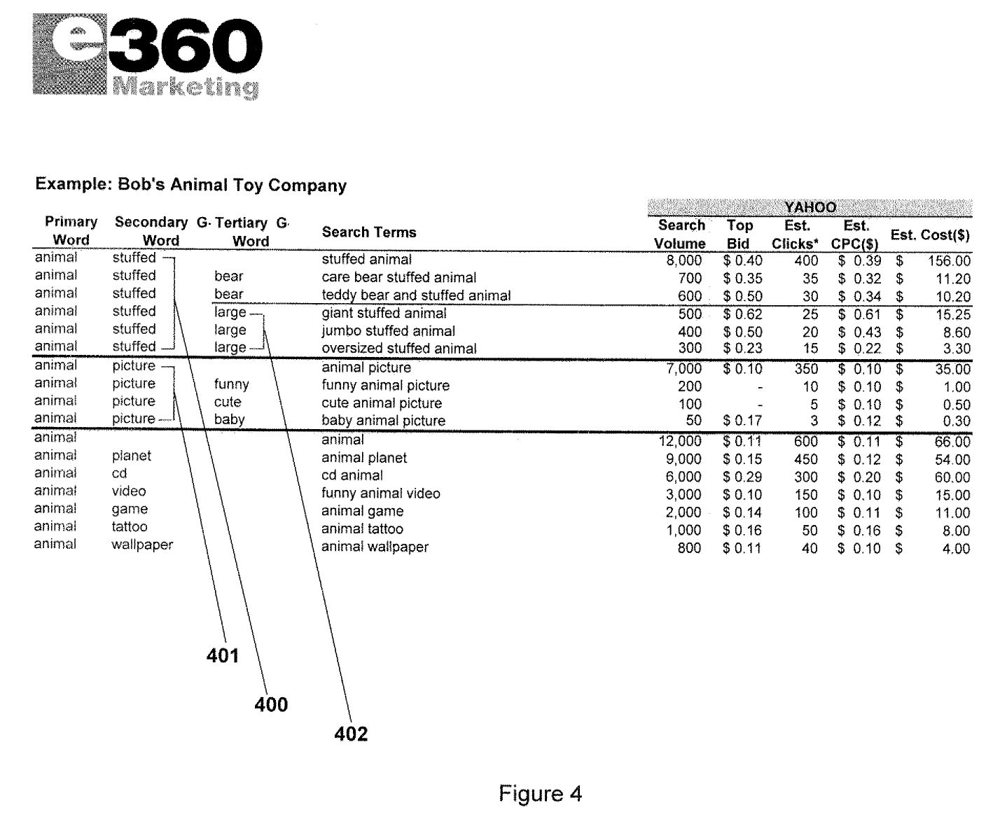

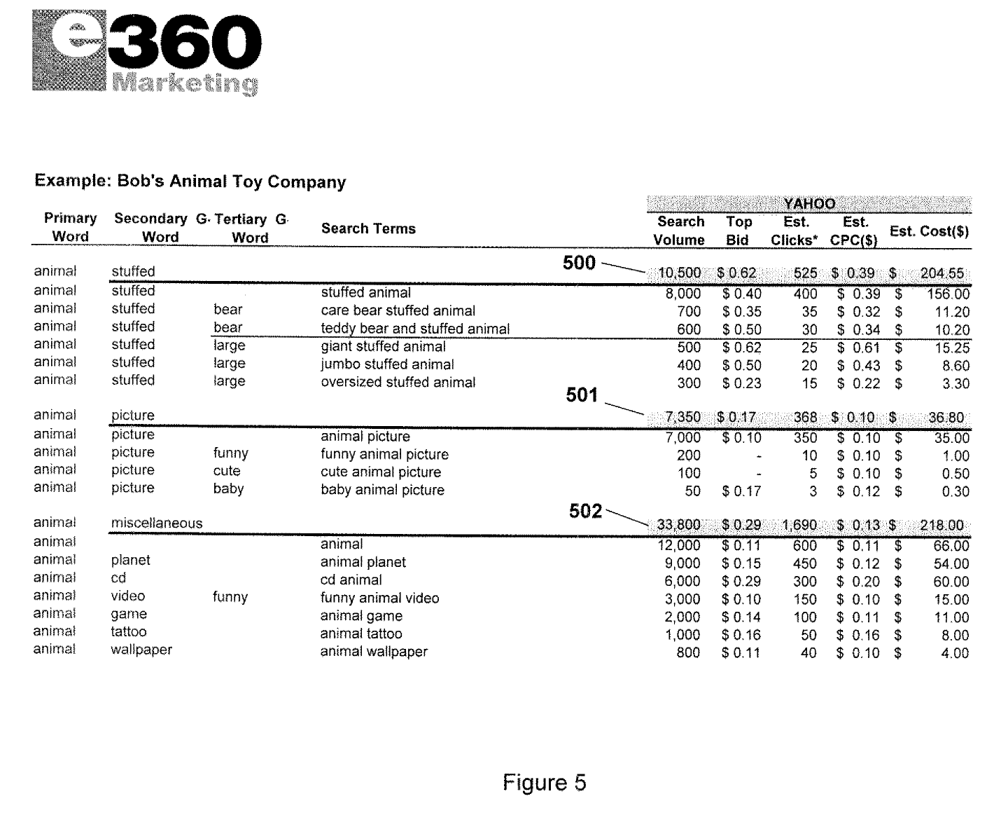

FIG. 3 shows an illustration of the breakdown of search terms, containing the primary word “animal”, into new g-words applied in a hierarchical keyword structure by Primary, Secondary, Tertiary (and so on) g-word groups. FIG. 3 shows a segment of search terms containing the original primary word “animal” 100 and an additional column 301 extracting new g-words present in each search term containing “animal”. Furthermore, a third column “Tertiary g-words” 302 contains additional g-words extracted from search terms containing both the primary word “animal” and secondary g-words of all types. Once these g-word patterns are extracted from the search terms, the application then gathers and sorts these new g-words into contiguous groups, as shown in FIG. 4—400, 401, 402. Associated statistics for search terms contained within the group, as shown in FIG. 5—500 501, 502, may be summarized for analysis and understanding.

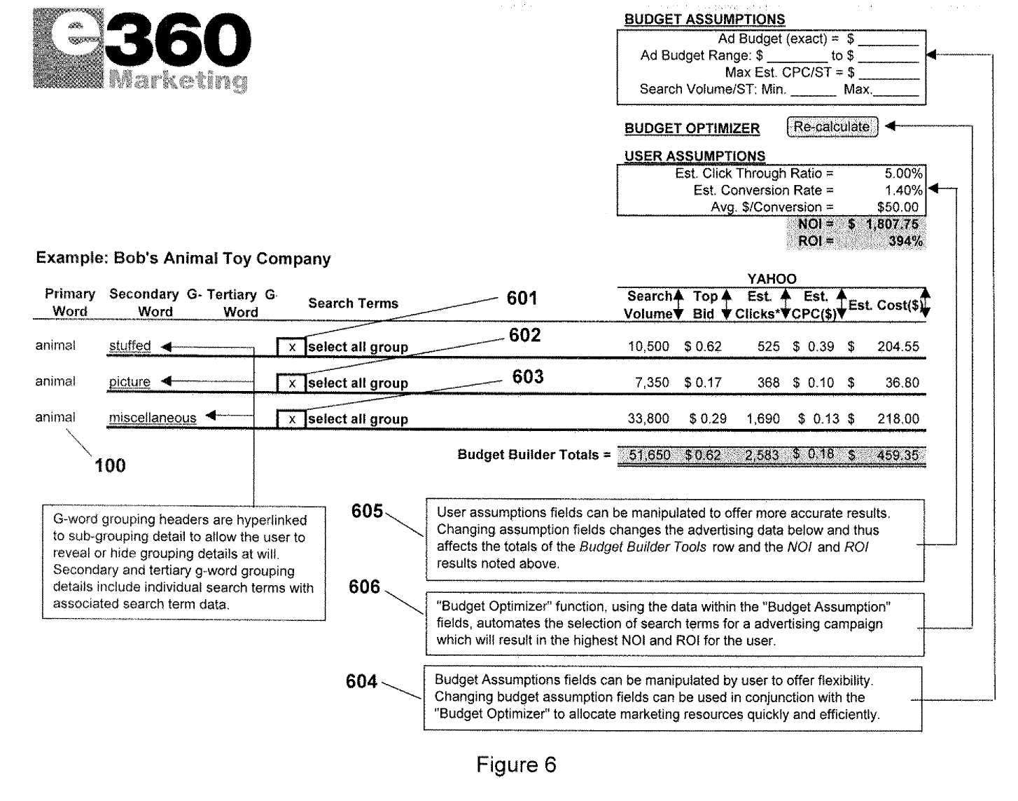

Then, in a preferred embodiment, hierarchical g-word structure may be revealed or hidden, selected or unselected, to offer the user maximum flexibility in analysis and understanding. FIG. 6 shows the hierarchical relationship from the primary word “animal” 100 to the secondary g-word groupings discovered via analysis. Because some g-words may be more or less relevant to the goals of the user, provision is made for selection or exclusion of each secondary g-word or g-word group, for budgetary purposes, in any convenient manner, in this case via selection boxes 601 602 603. In a further preferred embodiment, user assumption fields will be available to the user 604. The user may enter his/her expected click-through-rate, estimated conversion rate, estimated average revenue per transaction or any other possible future business metric that may be relevant which will be used to calculate an NOI and ROI figure for user consideration. The user assumption data fields are linked directly to the search data allowing for NOI and ROI results to change as the user selects and de-selects individual search terms and/or primary, secondary and tertiary g-word groups. Not shown is the ability at any level in the hierarchy to exclude an individual g-word, g-word group or search term and the associated search volume and advertising data from further consideration in the method.

In further preferred embodiments ‘Budget Assumption’ fields will be available to the user 605. The user may enter his/her expected advertising budget/budget range, preferred maximum estimated cost per click-through per search term, minimum/maximum search volume per search term, or any other possible future budget or cost metric that may be relevant which will be used in conjunction with the ‘Budget Optimizer’ function”.

In further preferred embodiments, a ‘Budget Optimizer’ function will be available to the user 606. The user, having populated the relevant ‘Budget Assumptions’ fields, can use the ‘Budget Optimizer’ to automate the allocation of marketing resources across the available, or pre-selected, search terms to ensure maximum NOI and ROI”.

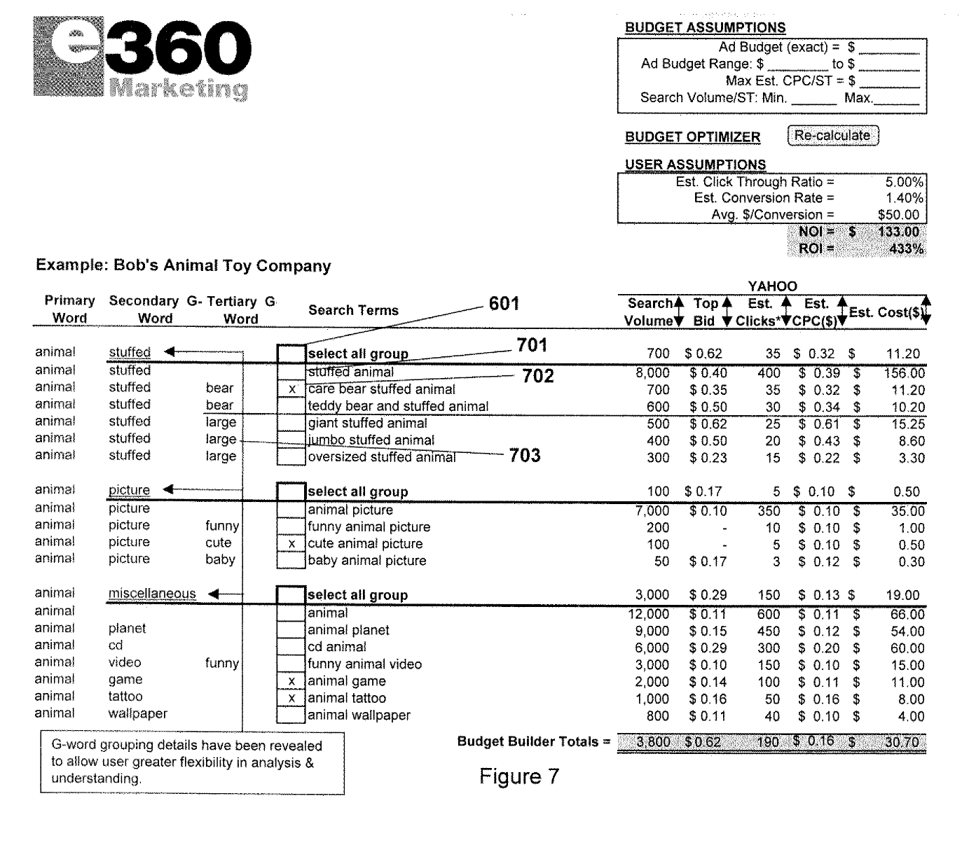

In FIG. 7, tertiary g-word patterning and search term details are revealed to allow for further analysis and understanding. This process may continue recursively, thus every level of g-word group 601 may have included or excluded g-words 701 702. At some point in the recursive decomposition, preferred embodiments may abstract g-word characteristics via user involvement or other automated or manual processes for improved understanding, as shown by the collapsing of “giant”, “jumbo” and “oversized” g-words into a group entitled “large” 703. In additional preferred embodiments the summary statistics use only the included selections, as will be seen in FIG. 7, so that budgetary computations and comparisons may be performed with ease.

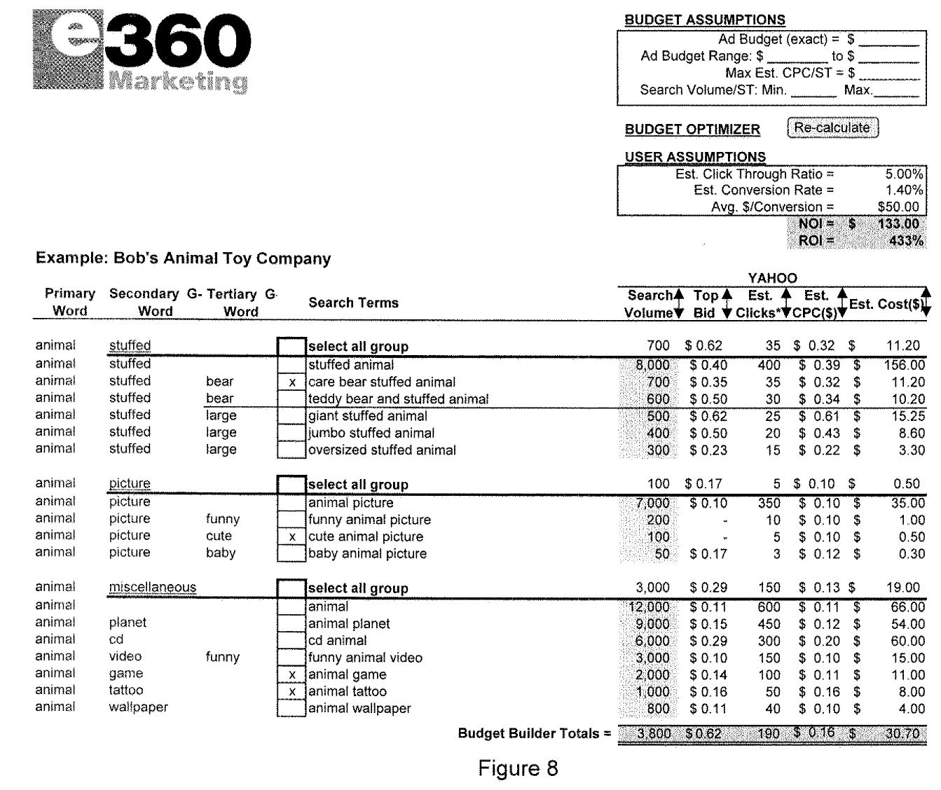

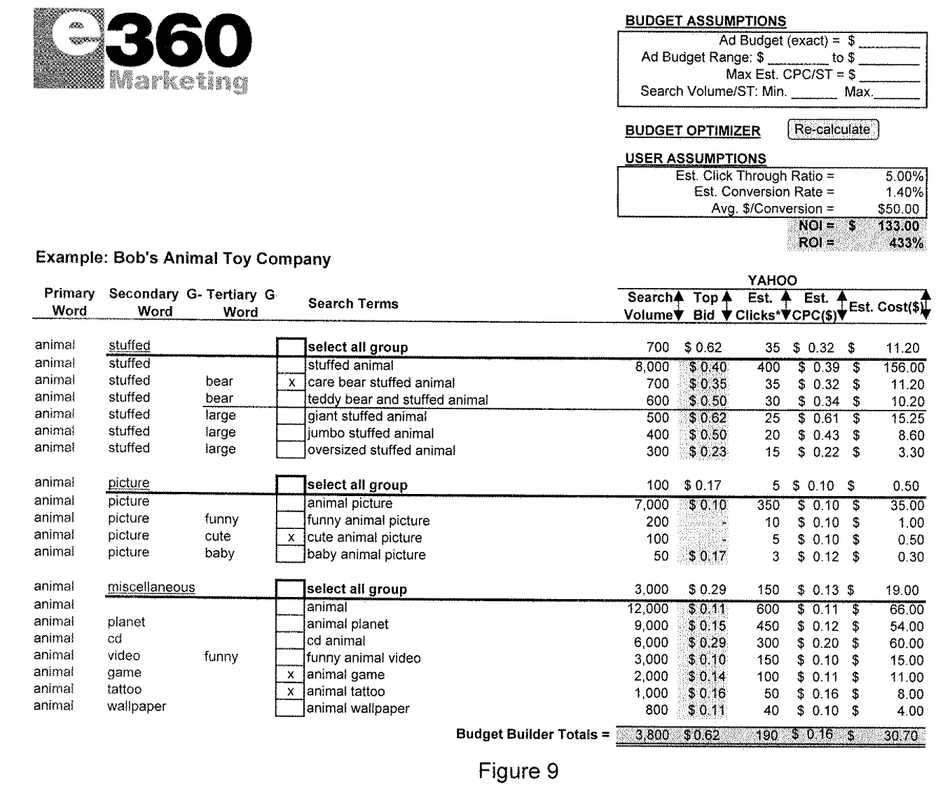

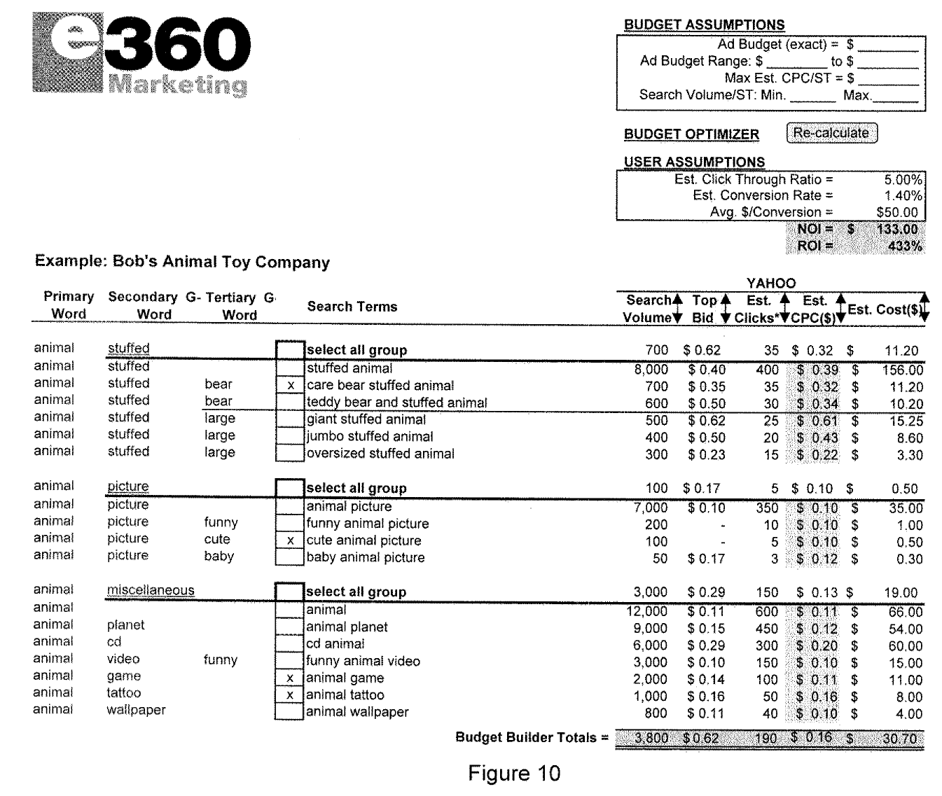

FIGS. 8, 9 and 10 shows additional data manipulation possibilities associated with each search term and g-word grouping, including search volume, top bid and cost per click. Preferred embodiments provide for user selection or exclusion of individual search terms or g-word groups, for example, to prepare estimated budgets based on proposed investment strategies.

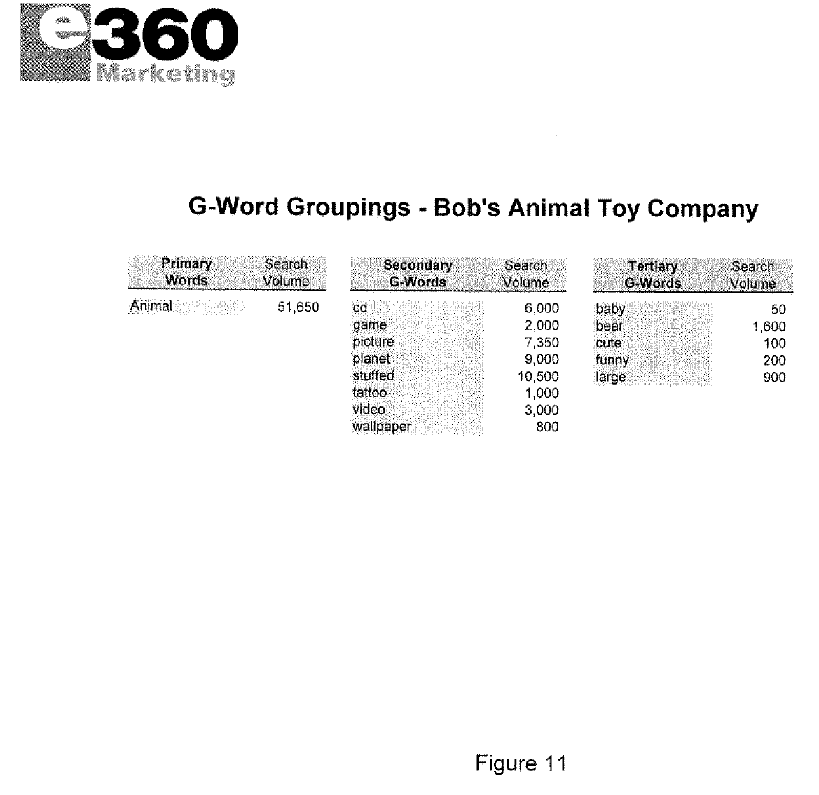

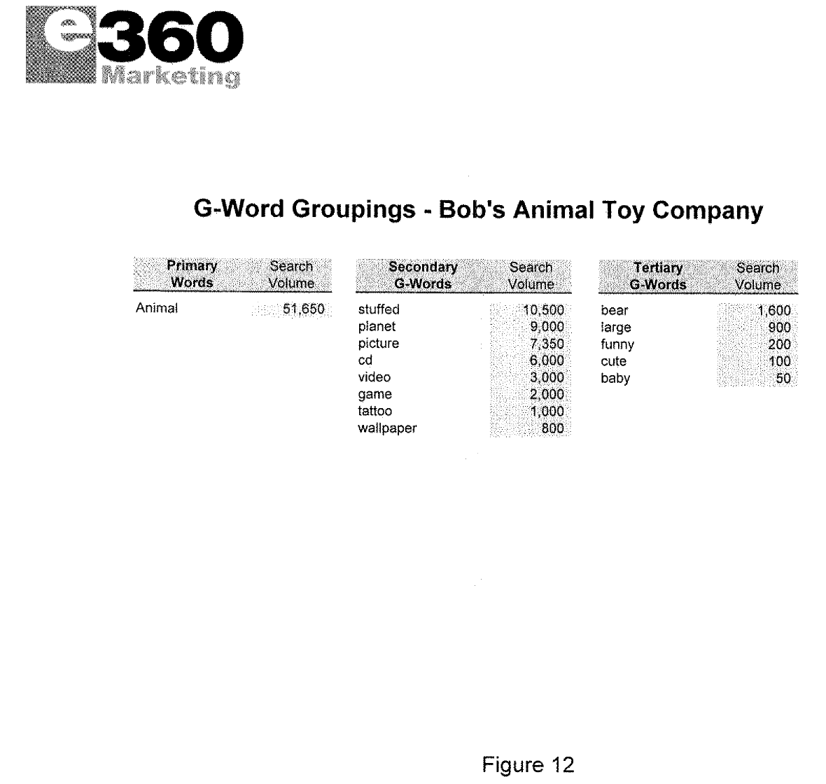

FIG. 11 further shows how the (eventually) selected g-words may be placed in hierarchical order. By ordering with respect to the associated search volume, highlighted in FIG. 12, the user may quickly understand the importance of each g-word relative to all other g-words.

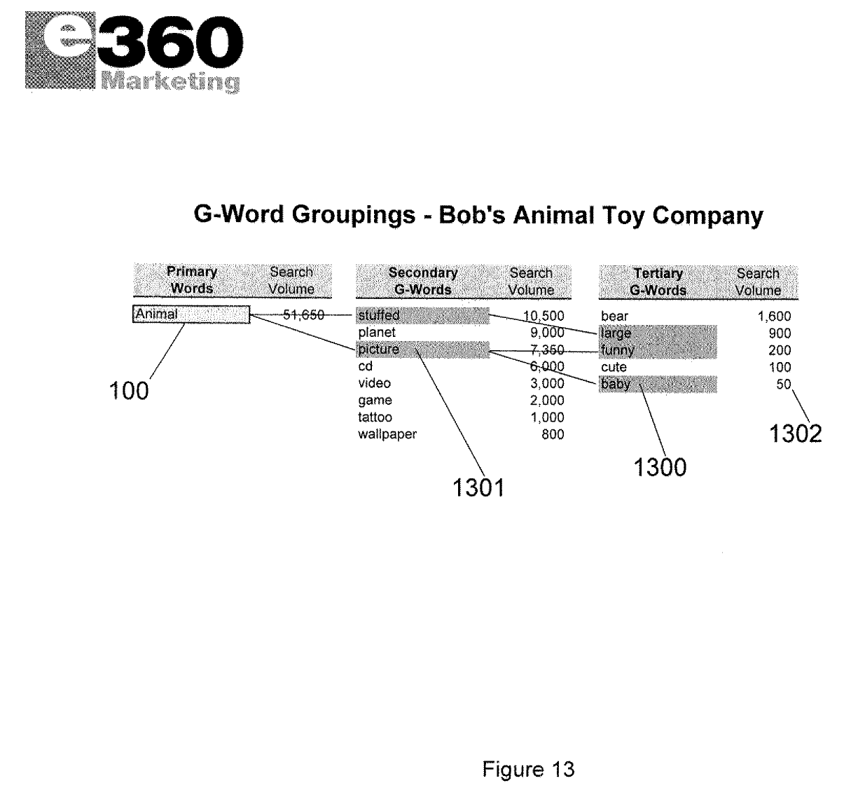

In a further inventive aspect, further preferred embodiments provide for graphical display of g-word relationships. FIG. 13 shows an example of primary word's relationship to the secondary and tertiary g-words. A path from primary through secondary to tertiary identifies a search term combination that contributed to the search volume number for that tertiary g-word. For example, a tertiary g-word “baby” 1300 shows a relationship deriving from a secondary g-word “picture” 1301, which itself derives from a primary word “animal” 100. Thus, the search volume of “50” 1302 is the number of times the search term “animal picture baby” occurred in the specific analysis of this example. It will be apparent that this technique may be extended to any depth in a hierarchy as may be desired.

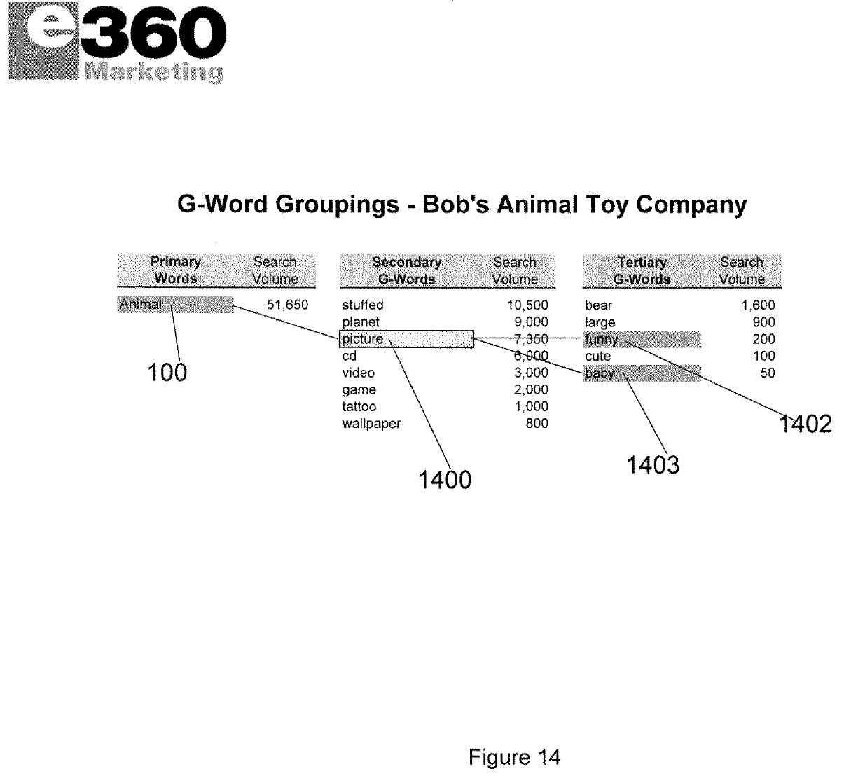

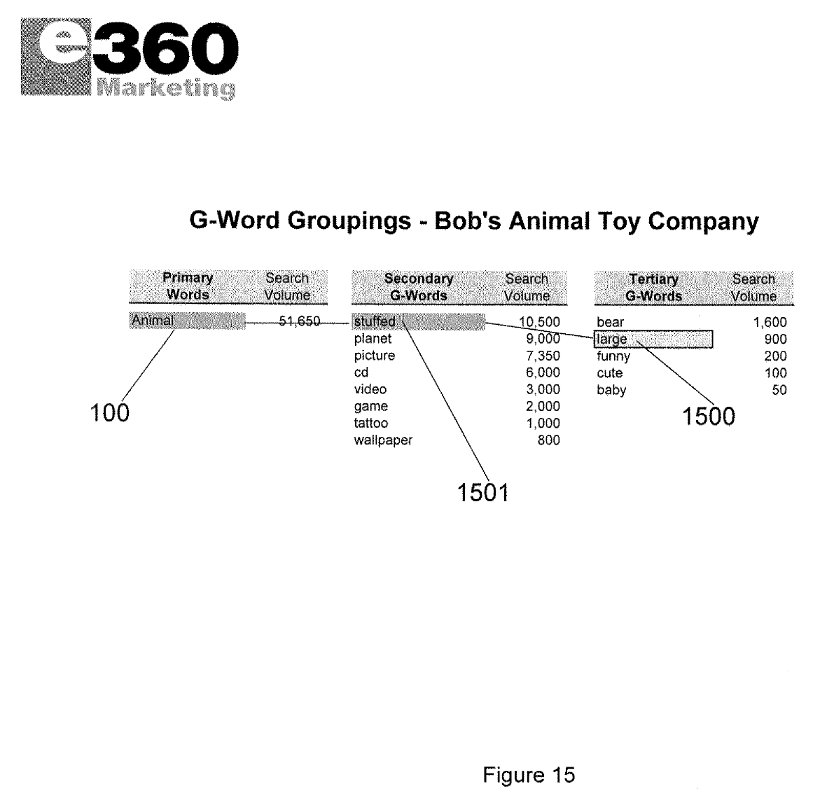

FIG. 14 shows another inventive aspect of preferred embodiments wherein a g-word, for example “picture” 1400 may be graphically represented as being derived from certain higher level primary words, such as “animal” 100 and further identifying lower level g-words 1402 1403 deriving from such g-word 1400. As another illustration, FIG. 15 similarly shows a tertiary g-word 1500 deriving from a secondary g-word 1501 which are themselves derived from primary words 100.

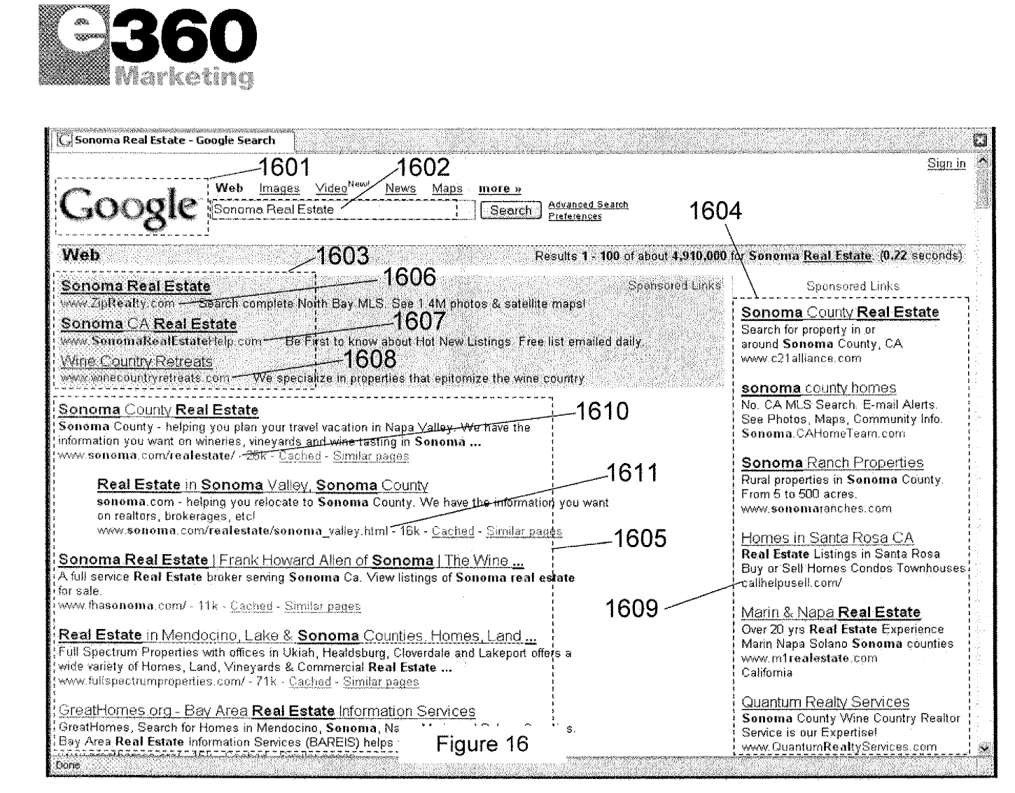

Additional inventive material is disclosed that focuses on the URLs selected by search terms that may or may not arise from the above described hierarchical search term process. Consider FIG. 16, showing a typical search engine results page for a typical search term inquiry.

Dashed rectangles have been added to help describe the desired display areas. The particular search engine used for the present example is identified as Google 1601, and the results presented are from the search term “Sonoma real estate” 1602. Search results are displayed in both natural position 1605 and sponsored positions 1603 1604. Sponsored listings for this search engine may occur either at the top of the page 1603 and will be referred to herein as “Sponsored Top Positions” or at the right side of the page 1604 where they will be referred to as “Sponsored Right Positions”.

The search engine identification field 1601 identifies the particular search engine for which the following results are obtained. This is critical information in determining the emphasis to put on the following results, since search engines differ in the volume of searches performed by users. This emphasis is termed search engine relevancy and is numerically based on the relative volume of searches performed on this search engine compared to all other search engines under consideration, during the qualifying time interval. Similarly, the specific search term under consideration 1602 can be characterized by the number of searches performed, using that search term, on a given search engine during a particular time interval.

Search engines typically return results in several categories, related to natural (free) or sponsored (paid) results, and such categories may in the future be modified, expanded, have their meaning changed, or in general have varying types of characteristics that would modify the desirability of a particular result listing in that category. To account properly for this possibly varying category desirability, i.e. predicting the likelihood of attracting user attention, the positioning relevancy data must include several types of positioning and the relative ranking within each type of position. FIG. 16 identifies a typical Google search result, showing the Sponsored Top Positions area 1603, the Sponsored Right Positions area 1604, and the Natural Listing Positions area 1605. Within the sponsored top area 1603 the number 1 sponsored top listing 1606 is shown. Within the sponsored right position area 1604 the fourth resulting listing 1609 is shown, and within the natural listing area 1605 the first 1610 and second 1611 position listings are shown.

Positioning Relevancy Data: Because the position order of a URL in the search results display is quite important in predicting likelihood of gaining user attention for that URL, this position order is an important parameter in the inventive method and is referred to as positioning relevancy data. As an example of position order, it will be observed that in Figure A, for this particular search engine 1601 and this particular search term 1602 the sponsored top positions 1603 contains three URLs. It will be further observed that the first (and therefore presumed best) position in the sponsored top search area 1603 is occupied by www.ZipRealty.com 1606, position two 1607 goes to www.SonomaRealEstateHelp.com and position three 1608 goes to www.winecountryretreats.com. Replicated main domain URL addresses with differing extensions, are also important and are included 1611 in a preferred embodiment just as would any non-replicated web site.

We will now describe the computational methods employed in a preferred embodiment of the inventive method.

As an overview, each search term included in the analysis delivers, for each search engine the search term is presented to, an ordered result of specific web sites that were displayed on the varying search results. These web sites are linked to the specific result position in which they were displayed. These results are recorded in working tables. Since certain web sites occur repeatedly in response to the chosen search terms, there will most likely be multiple entries for each web site, with differing positional results for differing search terms across differing search engines. To facilitate the subsequent analysis, positional results are given easily recorded names. Four tables are employed to record the range of search results.

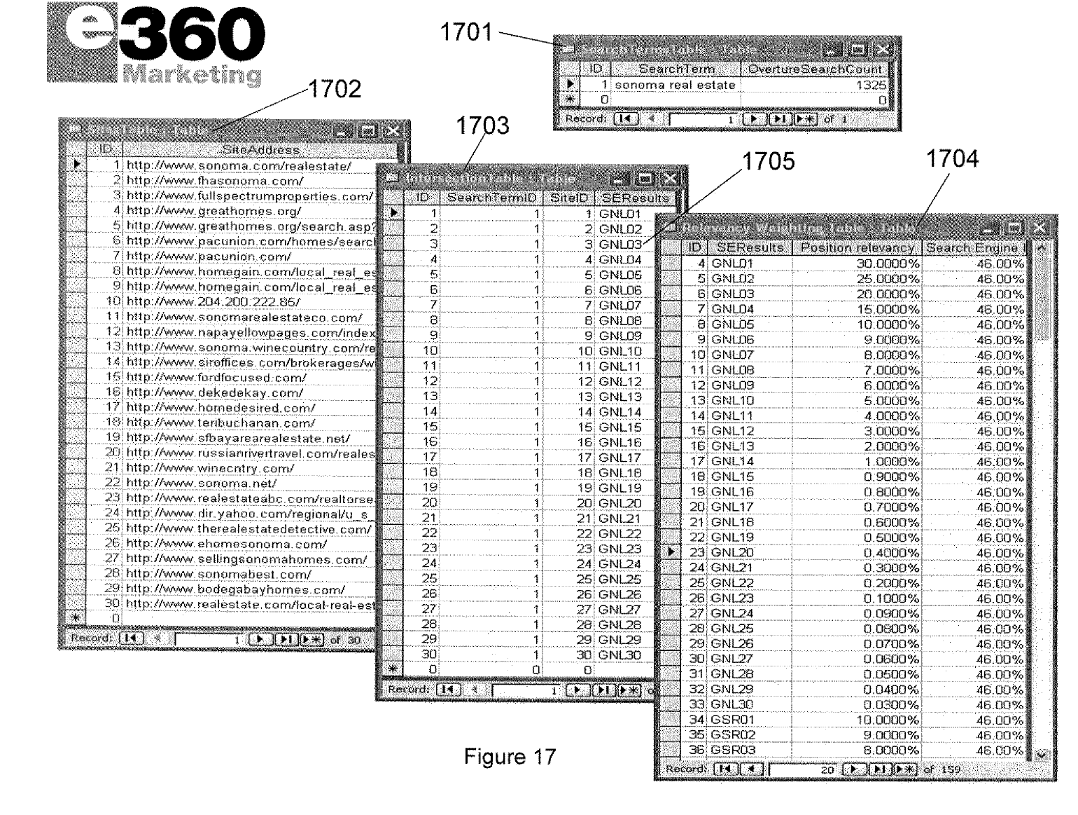

FIG. 17 shows each of the four tables: The Search Term Table 1701, the Site Table 1702 the Intersection Table 1703 and the Relevancy Weighting Table 1704.

The Search Term Table 1701 records each search term used in the application and the search volume for each search engine for a given time interval.

The Sites Table 1702 records each occurrence of a web site, giving it an index value.

The Intersection Table 1703 records each web site returned for each search inquiry performed, and the resulting positions achieved by those web sites.

The Relevancy Weighting Table 1704 gives the assumed likelihood of a user choosing a web site as a function of the position ordering for the particular search engine. In a preferred embodiment, the position orders are identified as an identifier combining search engine identification with resulting position. For example, in FIG. 17, the identifier “GNL03” 1705 identifies any Google Natural Listing in the third position.

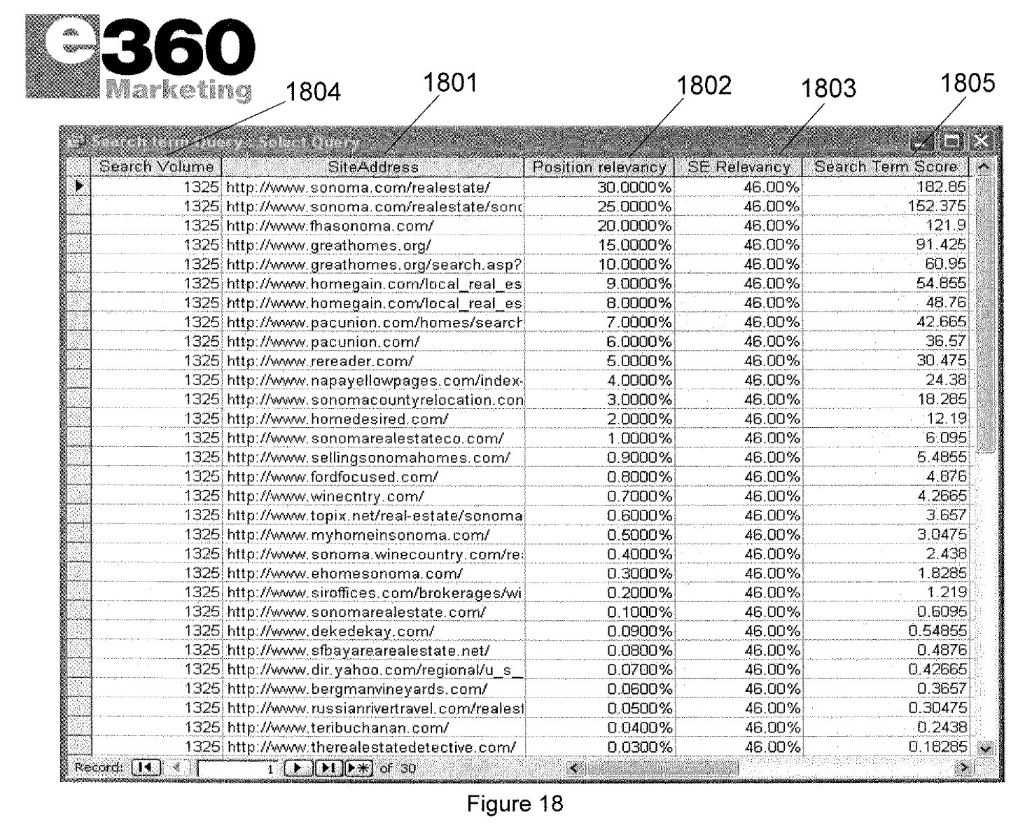

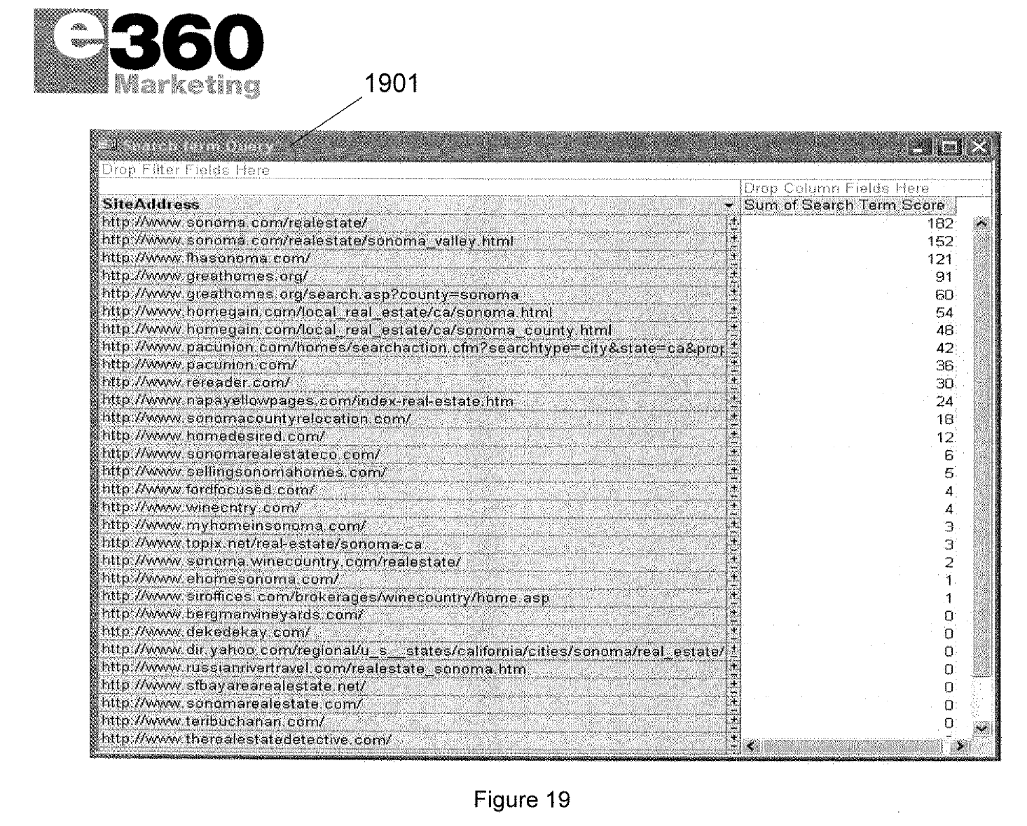

In further preferred embodiments, computations are now performed using information from the four tables. Referring to FIG. 18, to determine an overall URL ranking, for each returned URL 1801 the product of position relevancy 1802, search engine relevancy 1803 and search term volume 1804 is computed, producing a score 1805. Then, all such products for each URL are summed, forming an overall score by URL. When sorted by overall score, as shown in FIG. 19, this creates a table 1901 effectively ranking each URL in order of likely user selection.

All known computational techniques for ranking URLs are contemplated, including one or more methods wherein there are differing positional relevancy measures for each search engine, wherein search term volume is used non-linearly, wherein psychometric data is incorporated for more accurate modeling of results, or wherein additional data is extracted from search results and incorporated to enhance results.

Further, in additional preferred embodiments, powerful competitive information can be obtained by targeting a competitor's or competitors' websites, and adjusting the positional selection criteria to select only sponsored search data, thus giving insight into competitors behaviors, including PPC search term strategies and PPC marketing budgets. Applying the process over a set of search terms, the application uses the sponsored position data of each search with data on estimated click-through costs and estimated number of click-through to determine the following competitive intelligence:
The search terms on which a competitor is bidding. By considering only sponsored listing positions, any keyword will return a list of web sites bidding on that keyword. Noting the position of any particular URL will reveal the bid strategy of the URL owner relative to that keyword, and repeating over the range of relevant keywords will produce a competitor's bid profile.
Similarly, the position of every competitor ad placed on every search term may be determined.
Approximate search volume, CT and CTR for each ad and each search term. Thus in the region of relevant search terms, a competitors likely marketing budget and expected traffic volume may be estimated.
Total marketing budget spent on each search engine. It will be apparent that using the statistics of volume and bid cost for that keyword, and integrating over relevant keywords, a budget estimate for each web site by search engine may be computed.

Because the process of creating the above result can be automated, it can be treated as an inner loop to more global search and optimization methods, allowing very data intensive analysis.

Thus, specific embodiments and applications of methods and apparatus for optimizing investments in web marketing have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of obtaining data relating to web site promotion and operation comprising at least one of providing and operating an automated process that includes the following steps:
obtaining search volume and advertising cost data regarding historical usage of individual search terms containing a primary word;
identifying a plurality of secondary g-words that are contained within the search terms;
grouping the plurality of secondary g-words; and
producing a summary of search volume and advertising cost data for at least some of the secondary g-word groupings.

2. The method of claim 1, further comprising obtaining at least some of the search volume and advertising cost data from at least one of screen scraping, and other websites via private third party agreements.

3. The method of claim 1, wherein the step of choosing the first primary word comprises obtaining a word from at least one of a customer, a concordance technology across selected web sites, and applying at least one of dictionary, thesaurus, misspelling, and permutations to previously selected primary words.

4. The method of claim 1, wherein the step of identifying the plurality of secondary g-words comprises obtaining a set of historical searches, and selecting as one of the secondary g-words a g-word that occurs along with the primary word in at least one of the historical searches.

5. The method of claim 1, wherein the step of identifying a plurality of secondary g-words comprises obtaining a set of historical searches, and selecting as one of the secondary g-words a g-word contained within a search term that has particular search volume or advertising cost data attributes.

6. The method of claim 1, wherein some secondary g-word groupings contain at least one of the same search terms and the same search volume and advertising cost data.

7. The method of claim 1, further comprising ordering the secondary g-word groupings at least partially as a function of the number of secondary g-words within a secondary g-word group in a set of historical search data.

8. The method of claim 1, further comprising ordering the secondary g-word groupings at least partially as a function of setting a low boundary for at least one of occurrence and search volume frequencies of selected ones of the secondary g-words in a set of historical search data.

9. The method of claim 1, further comprising ordering the secondary g-word groupings at least partially as a function of setting a high boundary for at least one of occurrence and search volume frequencies of selected ones of the secondary g-words in a set of historical search data.

10. The method of claim 1, further comprising ordering the secondary g-word groupings at least partially as a choosing of relatively inexpensive ones of the secondary g-words.

11. The method of claim 1, further comprising setting an evaluation criterion that is at least in part a function of the search volume and advertising cost data of the search terms contained within the secondary g-word groupings.

12. The method of claim 11 wherein the evaluation criterion includes at least one of a click through ratio, a monetary budget, an estimated conversion rate of website visitors, an average dollar value per converted website visitor, a maximum estimated cost per click through of search terms, a minimum or maximum search volume per search term, and a “Budget Optimizer” function which automatically builds an optimized marketing campaign based on the other evaluation criterion.

13. The method of claim 1, further comprising calculating a metric that represents an estimated value of running the advertising campaign using selected search terms from the first secondary g-word grouping.

14. The method of claim 13, further comprising re-calculating the metric as a function of at least one of a user selecting different ones of the secondary g-word groupings, and a “Budget Optimizer” function.

15. The method of claim 13 further comprising including in at least one of the secondary g-word groupings a tertiary g-word that is related to the primary and at least one of the secondary g-words, and including volume and cost information related to the tertiary search term in calculating the metric.

16. The method of claim 13, further comprising selecting the tertiary g-word as a function of its having a lower frequency than any of the plurality of secondary g-words in a set of historical search data.

17. The method of claim 13, further comprising calculating the metric for other groupings of a second primary word and its corresponding secondary g-word groupings and associated search volume and advertising cost data, and combining the metrics for the first and second primary words.

18. A method of ranking URLs, comprising at least one of providing and operating an automated process that includes the following steps:
performing a search or searches using one or more relevant initial words;
collecting data associated with the search or searches, and
using the data to order the resulting URLs according to a ranking criterion.

19. The method of claim 18, wherein the step of collecting data comprises at least one of examining natural listings within the search results, examining sponsored listings within the search results, and examining local listings within the search results.

20. The method of claim 18, wherein the ranking criterion is selected from the group consisting of weighting the search terms by search volume, weighting the search engines by relative total search traffic, and weighting the search engine results positions by the expected click-through % of total viewer click-through.
